(19) United States
(12) Patent Application Publication
(10) Pub. No.: US 2004/0174433 A1
(43) Pub. Date: Sep. 9, 2004

(54) Image processing apparatus

(75) Inventor: Fumiko Uchino, Otokuni-gun (JP)

Correspondence Address: McDERMOTT, WILL & EMERY, 600 13th Street, N.W., Washington, DC, 20005, US

(73) Assignee: Minolta Co., Ltd.

(21) Appl. No.: 10/449,532

(22) Filed: Jun. 2, 2003

(30) Foreign Application Priority Data
Mar. 7, 2003 (JP) P2003-061849

(51) Int. Cl. H04N 5/225

(52) U.S. Cl. 348/207.99

(57) ABSTRACT

In a computer, a number of pieces of object-color component data each indicative of spectral reflectance of the subject are stored. First, a plurality of pieces of object-color component data to be compared are selected. The same illuminant component data indicative of a spectral distribution of illumination light is combined into each of the selected plurality of pieces of object-color component data, thereby generating a plurality of pieces of composite image data. The composite image data is further subjected to adjustment of brightness and adjustment of the size of the subject and the resultant data is displayed on a display. By the operation, images of the subject are reproduced with the same spectral distribution and the same intensity of illumination light and the same scaling.

This application is based on application No. 2003-061849 filed in Japan, the contents of which are hereby incorporated by reference.

### BACKGROUND OF THE INVENTION

1. Field of the Invention

The present invention relates to a technique of processing image data.

2. Description of the Background Art

For example, in the medical field, progress of treatment to an affected area of a patient is observed by obtaining image data of the affected area at different times and viewing and comparing the obtained a plurality of pieces of image data later. In the case of obtaining a plurality of pieces of image data to be compared, it is preferable to achieve uniform image capturing conditions such as illumination environment to the subject.

However, times and places of capturing a plurality of pieces of image data to be compared are generally different from each other, so that it is impossible to achieve uniform image capturing conditions. In the case of reproducing a plurality of pieces of image data, therefore, images of the subject under different conditions are reproduced. For example, when illumination light to the subject at the time of capturing a plurality of pieces of image data varies, images of the same subject are reproduced in different colors in a plurality of pieces of image data. It causes a problem such that, at the time of reproducing a plurality of pieces of image data, reproduction images of the subject cannot be accurately compared with each other.

### SUMMARY OF THE INVENTION

The present invention is directed to an image processing apparatus for processing data regarding an image.

According to the present invention, an image processing apparatus comprises: an image generating part for generating a plurality of pieces of composite image data by combining the same illuminant component data indicative of a spectral distribution of illumination light into each of a plurality of pieces of object-color component data corresponding to image data from which an influence of illumination light to a subject is eliminated; and an output part for outputting the plurality of pieces of composite image data, which have been generated, so as to be viewed.

Since the same illuminant component data is used to generate a plurality of pieces of composite image data, images of the subject under illumination light conditions of the same spectral distribution can be reproduced in the plurality of pieces of composite image data.

According to an aspect of the present invention, each of the plurality of pieces of composite image data includes a reference area obtained by photographing a reference subject of an achromatic color, and the image processing apparatus further comprises an image adjusting part for adjusting brightness of each of the plurality of pieces of composite image data so that the reference areas in the plurality of pieces of composite image data have the same brightness.

Since the brightness of each of the plurality of pieces of composite image data is adjusted so that the reference areas have the same brightness, images of the subject under illumination light conditions of the same intensity can be reproduced in the plurality of pieces of composite image data.

According to another aspect of the present invention, each of the plurality of pieces of composite image data includes a reference area obtained by photographing a reference subject of a predetermined size, and the image processing apparatus further comprises an image adjusting part for adjusting a size of the subject in each of the plurality of pieces of composite image data so that the reference areas of the plurality of pieces of composite image data have the same size.

Since the size of the subject in each of the plurality of pieces of composite image data is adjusted so that the reference areas have the same size, images of the subject can be reproduced at the same scale in the plurality of pieces of composite image data.

The present invention is also directed to an image processing method for processing data regarding an image.

The present invention is also directed to a program product having a program for allowing a computer to execute an imaging process.

Therefore, an object of the present invention is to provide a technique capable of reproducing images of the subject under the same conditions in a plurality of pieces of image data at the time of outputting the plurality of pieces of image data.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an example of an image processing system according to a preferred embodiment of the present invention;

FIG. 2 is a diagram showing a schematic configuration of a computer;

FIG. 3 is a diagram showing the configuration of main components of a digital camera;

FIG. 4 is a block diagram showing the functions of a digital camera according to a first preferred embodiment;

FIG. 5 is a flowchart showing the flow of operations of the digital camera according to the first preferred embodiment;

FIG. 6 is a diagram showing an example of arrangement of a subject, a patch and the digital camera;

FIG. 7 is a block diagram showing the functions of the computer according to the first preferred embodiment;

FIG. 8 is a flowchart showing the flow of operations of the computer according to the first preferred embodiment;

FIG. 9 is a diagram showing a screen displayed on a display for selecting illuminant component data;

FIG. 10 is a diagram showing a screen displayed on the display for designating a reference value;

FIG. 11 is a diagram showing a screen displayed on the display for designating a reference size;

FIG. 12 is a block diagram showing the functions of a digital camera according to a second preferred embodiment;

FIG. 13 is a flowchart showing the flow of operations of the digital camera according to the second preferred embodiment;

FIG. 14 is a diagram showing an example of arrangement of a calibration plate and the digital camera;

FIG. 15 is a diagram showing an example of arrangement of a subject and the digital camera;

FIG. 16 is a block diagram showing the functions of a computer according to the second preferred embodiment; and

FIG. 17 is a flowchart showing the flow of operations of the computer according to the second preferred embodiment.

### DESCRIPTION OF THE PREFERRED EMBODIMENTS

Hereinafter, preferred embodiments of the present invention will be described with reference to the drawings.

1. First Preferred Embodiment

1-1. General Configuration

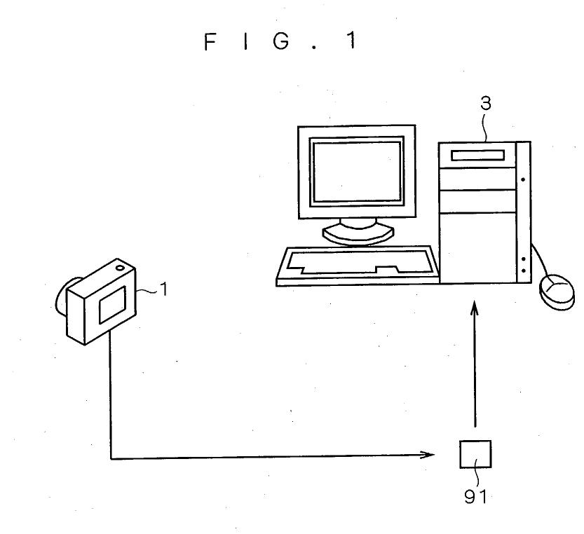

FIG. 1 is a schematic diagram showing an example of an image processing system to which an image processing apparatus according to a preferred embodiment of the present invention is applied. As shown in the figure, an image processing system 10 has a digital camera 1 functioning as an image input device, and a computer 3 functioning as an image reproducing apparatus.

The digital camera 1 photographs a subject to obtain image data, generates object-color component data which will be described later from the image data, and stores the object-color component data into a memory card 91 which is a recording medium. The object-color component data is transferred from the digital camera 1 to the computer 3 via the memory card 91. In the computer 3, a plurality of pieces of object-color component data received from the digital camera 1 is stored as a database. The computer 3 reproduces the plurality of pieces of image data by using the plurality of pieces of object-color component data in the database. The user views the plurality of pieces of image data reproduced in such a manner and compares the images of the subject reproduced.

Although only one digital camera 1 is drawn in FIG. 1, a number of digital cameras 1 may be included in the image processing system 10. The object-color component data may be transferred from the digital camera 1 to the computer 3 by electric transfer via an electric communication line such as the Internet, a dedicated transfer cable or the like.

1-2. Computer

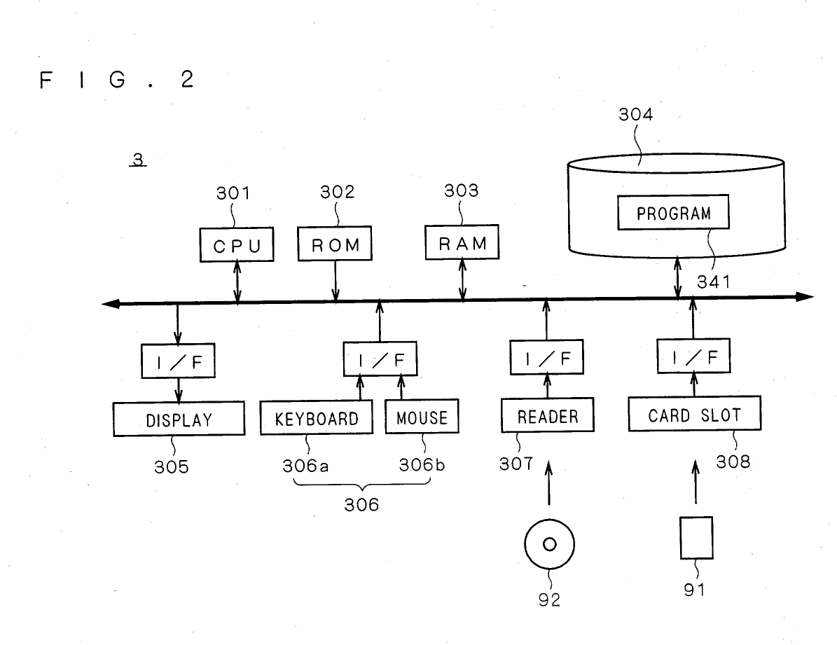

FIG. 2 is a diagram showing a schematic configuration of the computer 3. As shown in FIG. 2, the computer 3 has a configuration of a general computer system in which a CPU 301, a ROM 302 and a RAM 303 are connected to a bus line. To the bus line, a hard disk 304 for storing data, a program and the like, a display 305 for displaying various information, a keyboard 306a and a mouse 306b, serving as an operation part 306, for receiving an input from the user, a reader 307 for receiving/passing information from/to a recording disk 92 (optical disk, magnetic disk, magnetooptic disk or the like), and a card slot 308 for receiving/passing information from/to the memory card 91 are connected properly via interfaces (I/Fs).

The RAM 303, hard disk 304, reader 307 and card slot 308 can transmit/receive data to/from each other. Under control of the CPU 301, image data and various information stored in the RAM 303, hard disk 304, memory card 91 and the like can be displayed on the display 305.

A program 341 shown in FIG. 2 is stored from the recording disk 92 to hard disk 304 via the reader 307, properly read from the hard disk 304 to the RAM 303 and executed by the CPU 301. The CPU 301 operates according to the program 341, thereby realizing a function of processing image data. It makes the computer 3 function as an image processing apparatus according to the preferred embodiment. The details of the function realized when the CPU 301 operates according to the program 341 will be described later. In the case where the computer 3 has a communication function realized via an electric communication line such as the Internet, the program 341 may be obtained via the electric communication line and stored into the hard disk 304.

1-3. Digital Camera

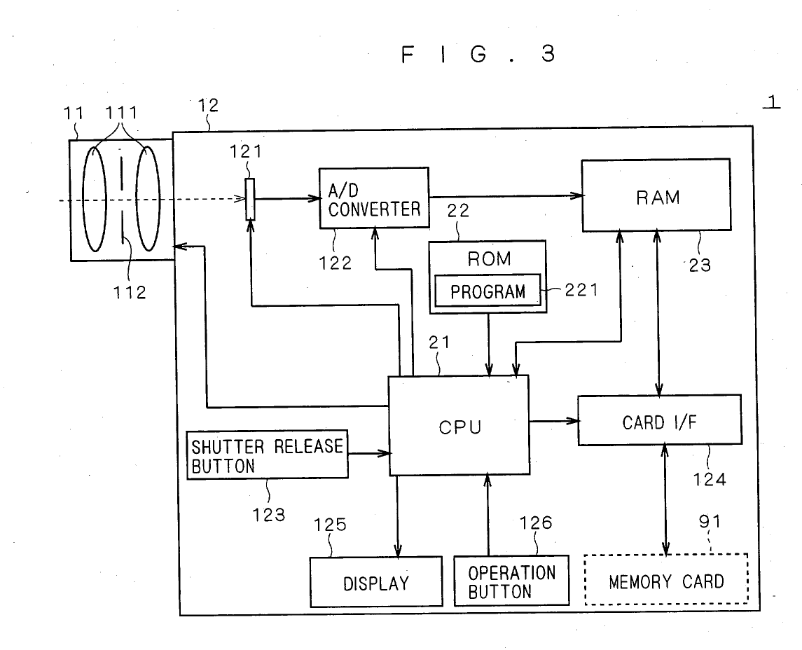

FIG. 3 is a block diagram showing main components of the digital camera 1. The digital camera 1 has a lens unit 11 for forming an image by incident light, and a main body 12 for processing image data. The lens unit 11 has a lens system 111 having a plurality of lenses, and an aperture 112. A light image of the subject formed by the lens system 111 is photoelectrically converted by a CCD 121 of the main body 12 into an image signal. The CCD 121 is a three-band image capturing device for capturing values of colors of R, G and B as values of pixels. An image signal outputted from the CCD 121 is subjected to processes which will be described later and is stored into the memory card 91 as an external memory detachably attached to the main body 12.

The main body 12 has a shutter release button 123, a display 125 and an operation button 126 functioning as a user interface. The user captures the subject via a finder or the like and operates the shutter release button 123, thereby obtaining image data of the subject. When the user operates the operation button 126 in accordance with a menu displayed on the display 125, setting of image capturing conditions, maintenance of the memory card 91 and the like can be performed.

In the configuration shown in FIG. 3, the lens system 111, the CCD 121, an A/D converter 122, the shutter release button 123, and a CPU 21, a ROM 22 and a RAM 23 serving as a microcomputer realize the function of obtaining image data. Specifically, when an image of the subject is formed on the CCD 121 by the lens system 111 and the shutter release button 123 is depressed, an image signal from the CCD 121 is converted into a digital image signal by the A/D converter 122. The digital image signal obtained by the A/D converter 122 is stored as image data into the RAM 23. The processes are controlled by the CPU 21 operating in accordance with a program 221 stored in the ROM 22.

The CPU 21, ROM 22 and RAM 23 provided for the main body 12 realize the function of processing image data. Concretely, the CPU 21 operates while using the RAM 23 as a work area in accordance with the program 221 stored in the ROM 22, thereby performing an image process on image data.

A card I/F (interface) 124 is connected to the RAM 23 and passes various data between the RAM 23 and memory card 91 on the basis of an input operation from the operation button 126. The display 125 displays various information to the user on the basis of a signal from the CPU 21.

1-4. Acquisition of Object-Color Component Data

Next, a process of obtaining object-color component data by the digital camera 1 will be described.

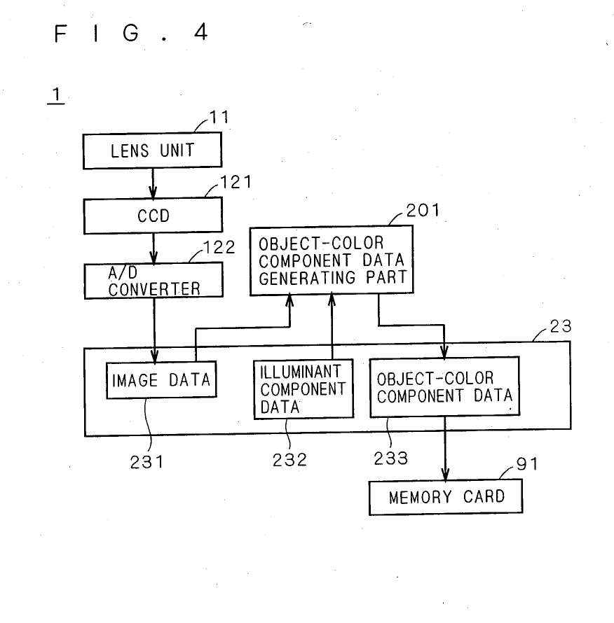

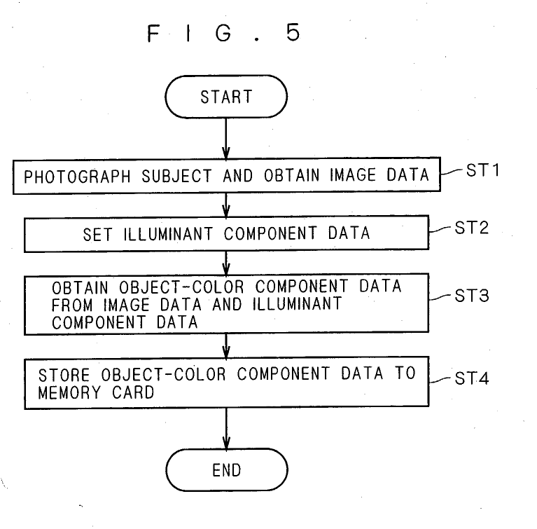

FIG. 4 is a diagram showing a function realized by the CPU 21, ROM 22 and RAM 23 of the digital camera 1 together with the other configuration. In the configuration shown in FIG. 4, an object-color component data generating part 201 is realized by the CPU 21, ROM 22, RAM 23 and the like. FIG. 5 is a flowchart showing the flow of photographing and imaging process of the digital camera 1. The operation of obtaining object-color component data of the digital camera 1 will be described below with reference to FIGS. 4 and 5.

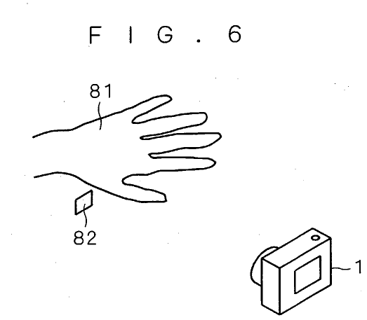

First, a subject is photographed and an image signal is obtained by the CCD 121 via the lens unit 11. An image signal outputted from the CCD 121 is sent from the A/D converter 122 to the RAM 23 and stored as image data 231 (step ST1). At the time of photographing, as shown in FIG. 6, a patch 82 as a reference subject together with a main subject 81, is also photographed. As the patch 82, a square-shaped sheet of paper of an achromatic color of white or gray, or the like is used. At the time of photographing, (the image capturing face of) the digital camera 1 and the patch 82 are disposed almost parallel to each other so that an area indicating the patch 82 is obtained as an almost square-shaped area in the image data 231.

After the image data 231 is stored in the RAM 23, illuminant component data 232 used at the time of obtaining object-color component data is set (step ST2). The illuminant component data 232 is data indicative of a spectral distribution of illumination light and, more generally, data indicative of an influence of illumination light exerted on image data. The intensity of the spectral distribution of the illuminant component data 232 is normalized by using the maximum spectral intensity as 1. The illuminant component data 232 indicates a relative spectral distribution of illumination light.

In the RAM 23 of the digital camera 1, a plurality of pieces of illuminant component data 232 corresponding to various illumination light (light sources) are prestored. The user selects one of the plurality of pieces of illuminant component data 232 with the operation button 126 in accordance with a light source used at the time of photographing. It is also possible to provide a multiband sensor for the digital camera 1, obtain a spectral distribution of actual illumination light on the basis of an output from the multiband sensor and store the spectral distribution as the illuminant component data 232 used at the time of obtaining object-color component data into the RAM 23. A multiband sensor in which filters each for transmitting only light of a wavelength band are provided for a plurality of light intensity detectors can be used.

After the illuminant component data 232 is set, object-color component data 233 is obtained as a component derived by eliminating an influence of an illumination environment from the image data 231 by the object-color component data generating part 201 with the image data 231 and illuminant component data 232 (step ST3). The object-color component data 233 is data substantially corresponding to spectral reflectance of the subject. A method of obtaining the spectral reflectance of the subject will be described below.

First, the wavelength of a visible range is set as λ, the spectral distribution of illumination light for illuminating the subject is set as E(λ), and spectral reflectance in a position of a subject corresponding to a pixel (hereinafter, referred to as “target pixel”) is set as S(λ). The spectral reflectance S(λ) is expressed as a weighted sum of three basis functions S₁(λ), S₂(λ) and S₃(λ) and weighted coefficients σ₁, σ₂ and σ₃ as follows.

$$S ( λ ) = {\sum }_{j = 1}^{3} σ jSj ( λ ) \qquad Equation 1$$

Therefore, a spectral distribution I(λ) of reflection light from a position on the subject corresponding to the target pixel (that is, incident light to the target pixel) is expressed as follows.

$$\begin{matrix}I ( λ ) = E ( λ ) \cdot S ( λ ) \\ = E ( λ ) \cdot {\sum }_{j = 1}^{3} σ jSj ( λ )\end{matrix} \qquad Equation 2$$

When the value (pixel value) regarding any of the colors of R, G and B (hereinafter, referred to as “target color”) of the target pixel is ρ_{c} and total spectral sensitivity (sensitivity considering spectral transmittance of the lens system 111 and spectral sensitivity of the CCD 121) of the target color of the digital camera is R_{c}(λ), ρ_{c} is expressed as follows.

$$\begin{matrix}{ρ}_{c} = \int {R}_{c} ( λ ) I ( λ ) ⅆ λ \\ = \int {R}_{c} ( λ ) \cdot E ( λ ) \cdot {\sum }_{j = 1}^{3} σ jSj ( λ ) ⅆ λ \\ = {\sum }_{j = 1}^{3} σ j \{ \int {R}_{c} ( λ ) E ( λ ) Sj ( λ ) ⅆ λ \}\end{matrix} \qquad Equation 3$$

In Equation 3, the basis function Sⱼ(λ) is a predetermined function and the total spectral sensitivity R_{c}(λ) is a function which can be preliminarily obtained by measurement. Information such as the basis function Sⱼ(λ) and the total spectral sensitivity R_{c}(λ) is prestored in the ROM 22 or RAM 23. The spectral distribution E(λ) of illumination light is stored in the RAM 23 as the illuminant component data 232.

Therefore, unknown values in Equation 3 are only the three weighted coefficients σ₁, σ₂ and σ₃. Equation 3 can be computed for each of the three colors of R, G and B in the target pixel. By solving the three equations, the three weighted coefficients σ₁, σ₂ and σ₃ can be obtained.

By substituting the three weighted coefficients σ₁, σ₂ and σ₃ obtained as described above and the basis function Sⱼ(λ) for Equation 1, the spectral reflectance S(λ) in the position on the subject corresponding to the target pixel can be expressed. Therefore, calculation of the weighted coefficients σ₁, σ₂ and σ₃ of the target pixel corresponds to calculation of the spectral reflectance S(λ) in the position on the subject corresponding to the target pixel.

Based on the method, the object-color component data generating part 201 of the digital camera 1 obtains the spectral reflectance of the position on the subject corresponding to each pixel (that is, the weighted coefficients σ₁, σ₂ and σ₃ of each pixel) while referring to the pixel value of the image data 231 and the illuminant component data 232. The obtained weighted coefficients σ₁, σ₂ and σ₃ of all of pixels are stored as the object-color component data 233 into the RAM 23 (step ST3). After the object-color component data 233 is obtained, the object-color component data 233 is transferred to the memory card 91 and stored (step ST4).

The object-color component data 233 which includes data corresponding to each pixel indicates the spectral reflectance of the subject, is also called a “spectral image”. More generally, the object-color component data 233 is data corresponding to image data from which the influence of illumination light is eliminated. However, when the weighted coefficients σ₁, σ₂ and σ₃ are obtained by the method, the intensity of actual illumination light is not reflected in the illuminant component data 232, so that the weighted coefficient σ₁, σ₂ and σ₃ to be obtained are values according to the intensity of actual illumination light. Specifically, when the intensity of actual illumination light is relatively high, the weighted coefficients σ₁, σ₂ and σ₃ which are relatively high are obtained. On the contrary, when the intensity of illumination light is relatively low, the weighted coefficients σ₁, σ₂ and σ₃ which are relatively low are obtained. Therefore, the object-color component data 233 is not absolute spectral reflectance but indicates a relative relationship among reflectances of respective wavelengths (hereinafter, referred to as “relative spectral reflectance”).

The digital camera 1 executes the series of processes for each target to be photographed (subject) and captures a plurality of pieces of the object-color component data 233. The obtained plurality of pieces of object-color component data 233 is transferred to the computer 3 via the memory card 91 and stored as a database in the computer 3.

1-5. Reproduction of Object-Color Component Data

A process of reproducing image data by using the object-color component data 233 by the computer 3 will now be described.

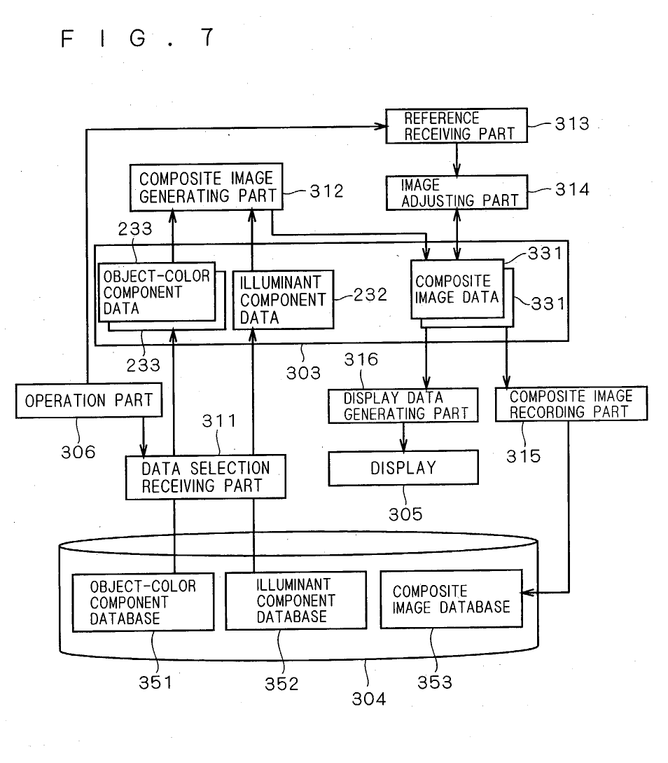

FIG. 7 is a block diagram showing the functions realized when the CPU 301 of the computer 3 operates according to the program 341 together with the other configuration. In the configuration of FIG. 7, a data selection receiving part 311, a composite image generating part 312, a reference receiving part 313, an image adjusting part 314, a composite image recording part 315 and a display data generating part 316 are realized when the CPU 21 operates according to the program 341.

As shown in the figure, in the hard disk 304, an object-color component database 351 constructed by a plurality of pieces of object-color component data 233 obtained by the digital camera 1 is provided. Moreover, in the hard disk 304, an illuminant component database 352 constructed by a plurality of pieces of illuminant component data 232 is provided. The illuminant component data 232 is data indicative of a spectral distribution of illumination light as described above and, more generally, data indicative of an influence of the illumination light on image data.

In the computer 3, the user is allowed to view an image of the subject formed by the object-color component data 233. Since the object-color component data 233 cannot be provided for display on the display 305, the computer 3 combines the illuminant component data 232 into the object-color component data 233 and displays the resultant image data (hereinafter, referred to as “composite image data”) on the display 305. By the process, the user can view and compare the image of the subject formed by the object-color component data 233. The illuminant component database 352 includes a plurality of pieces of illuminant component data 232 as candidates to be used for generating the composite image data. As the illuminant component data 232, data for various illumination light (light sources) such as D65 of the CIE standard, D50 of the CIE standard, incandescent lamp, fluorescent lamp and sunlight exist.

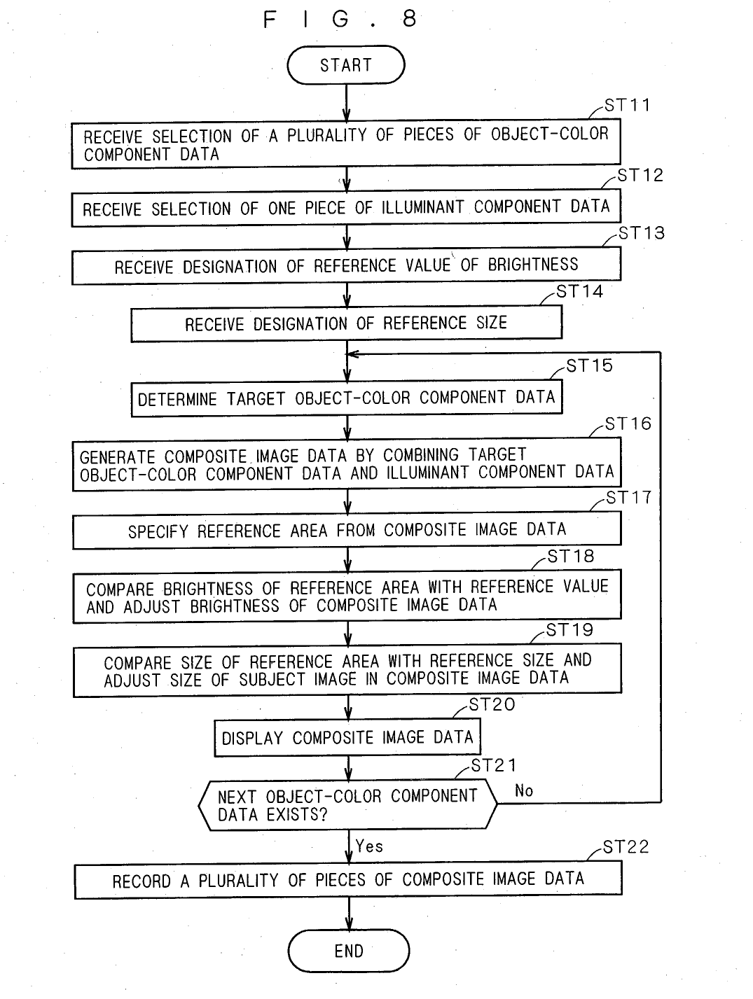

FIG. 8 is a flowchart of a process executed by the CPU 301 in accordance with the program 341. Concretely, FIG. 8 shows the flow of a process of reproducing composite image data by using the object-color component data 233. The process of the computer 3 will be described below with reference to FIGS. 7 and 8.

First, when the user gives an instruction via the operation part 306, a plurality of pieces of object-color component data 233 are selected from the object-color component database 351. The instruction of selection given by the user is received by the data selection receiving part 311, and the selected plurality of pieces of object-color component data 233 are read from the hard disk 304 to the RAM 303. In such a manner, the plurality of pieces of object-color component data 233 desired by the user to be compared are determined (step ST11).

Subsequently, by an instruction of the user given via the operation part 306, one piece of the illuminant component data 232 which is used for generating composite image data is selected from the illuminant component database 352. FIG. 9 is a diagram showing an example of a screen displayed on the display 305 for selecting the illuminant component data 232. As shown in the figure, a list of names of the illuminant component data 232 included in the illuminant component database 352 is displayed on the display 305. The user selects the name of the desired illuminant component data 232 with a mouse pointer MC and clicks a command button 361 indicating “OK”. By the operation, the instruction of selecting one piece of illuminant component data 232 is received by the data selection receiving part 311 and the selected illuminant component data 232 is read to the RAM 303 (step ST12).

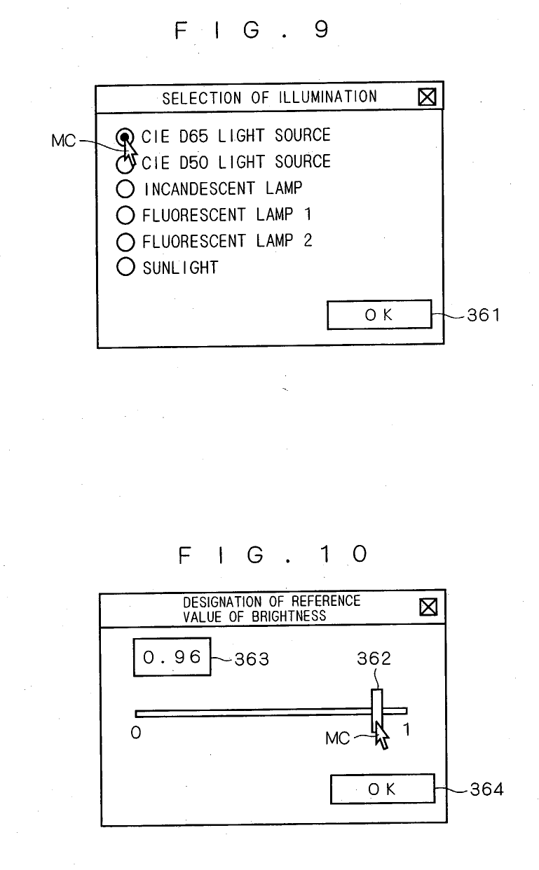

After that, by an instruction of the user via the operation part 306, a reference value as a reference of adjusting brightness of composite image data is designated. FIG. 10 is a diagram showing an example of a screen displayed on the display 305 for designating a reference value. The user can designate the reference value by a numerical value in a range from 0 to 1 by moving a slider control 362 displayed on the display 305 with the mouse pointer MC or by directly entering a numerical value to an input box 363. In the case of designating the reference value by moving the slider control 362, it is desirable to update a numerical value displayed in the input box 363 with the movement. An instruction of designating the reference value is received by the reference receiving part 313 by clicking a command button 364 indicating “OK” (step ST13).

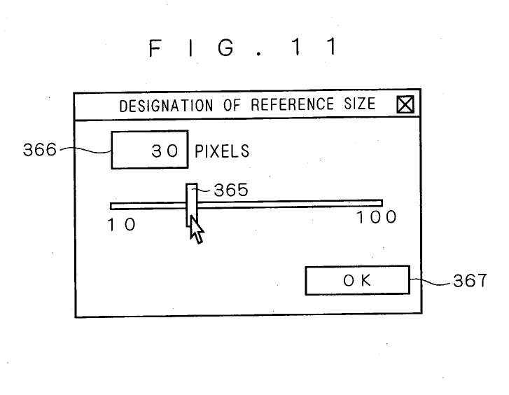

Further, by an instruction of the user via the operation part 306, the reference size as a reference of adjustment of the size of a subject in composite image data is designated by the number of pixels. FIG. 11 is a diagram showing an example of a screen displayed on the display 305 for designating the reference size. The user can designate the reference size by a numerical value in a range from 10 to 100 by moving the slider control 365 displayed on the display 305 with the mouse pointer MC or entering a numerical value directly to the input box 366. In a manner similar to the case of designating the reference value of brightness, in the case of designating a reference size by moving the slider control 365, it is desirable to update the numerical value in the input box 366 with the movement. The instruction of designating the reference size is received by the reference receiving part 313 by clicking a command button 367 indicating “OK” (step ST14).

Subsequently, one piece out of the plurality of pieces of object-color component data 233 read onto the RAM 303 is determined as an object of process (hereinafter, referred to as “target object-color component data”) (step ST15).

After the target object-color component data is determined, the target object-color component data and illuminant component data 232 is inputted to the composite image generating part 312. The composite image generating part 312 obtains the spectral reflectance S(λ) in each position on the subject by using data corresponding to each pixel in the target object-color component data as the weighted coefficient σⱼ in Equation 1. The basis function Sⱼ(λ) is prestored in the hard disk 304. The obtained spectral reflectance S(λ) in each position on the subject and the spectral distribution E(λ) of illumination light indicated by the illuminant component data 232 are used for Equation 2 and multiplied by each other, thereby obtaining a spectral distribution I(λ) (hereinafter, referred to as “composite spectral distribution”). By the computation, composite image data 331 in which each pixel is expressed by the composite spectral distribution I(λ) is generated. The composite spectral distribution I(λ) corresponds to a spectral distribution of reflection light from the subject when it is assumed that the subject expressed by the target object-color component data is illuminated with illumination light indicated by the illuminant component data 232.

By substituting the composite spectral distribution I(λ) into Equation 4, each of pixels in the composite image data 331 can be also expressed by tristimulus values (XYZ values). In Equation 4, R_{X}(λ), R_{Y}(λ) and R_{Z}(λ) are color matching functions of the XYZ color system.

$$\begin{matrix}X = \int {R}_{X} ( λ ) I ( λ ) ⅆ λ \\ Y = \int {R}_{Y} ( λ ) I ( λ ) ⅆ λ \\ Z = \int {R}_{Z} ( λ ) I ( λ ) ⅆ λ\end{matrix} \qquad Equation 4$$

Each of pixels of the composite image data 331 can be also expressed by RGB values by converting tristimulus values (XYZ values) to RGB values by a known matrix computation. Therefore, the composite image data 331 is data which can be easily provided to be displayed on the display 305 (step ST16).

Although the composite image data 331 generated in such a manner may be displayed, in the preferred embodiment, the composite image data 331 is further subjected to brightness adjustment and adjustment of the size of the subject. At the time of performing the adjustments, each of the pixels of the composite image data 331 is expressed in the composite spectral distribution I(λ).

At the time of adjustment of the composite image data 331, first, an area indicative of the patch 82 in the composite image data 331 is specified as a reference area by the image adjusting part 314. Since the patch 82 has a square shape and an achromatic color, the reference area has an almost square shape and the composite spectral distribution I(λ) of pixels included in the reference area is a flat distribution with small variations in intensity of each wavelength. Therefore, by finding out the area satisfying such a condition from the composite image data 331, the reference area can be specified. Alternatively, the composite image data 331 is displayed on the display 305 and the user may designate the reference area via the operation part 306 on the basis of the displayed composite image data 331 (step ST17).

The image adjusting part 314 adjusts the brightness of the composite image data 331 so that brightness of the specified reference area coincides with the reference value received by the reference receiving part 313. Concretely, the reference value is divided by brightness of the reference area to derive an adjustment coefficient, and the composite spectral distribution I(λ) of each pixel in the composite image data 331 is multiplied by the derived adjustment coefficient. As the brightness of the reference area, an average value of spectral intensity in a specific wavelength (for example, 560 nm) obtained from the composite spectral distribution I(λ) of each pixel included in the reference area is used. With the brightness, the brightness of the whole subject in the composite image data 331 is adjusted. Thus, the brightness of the reference area in the adjusted composite image data 331 coincides with the reference value (step ST18).

Subsequently, the image adjusting part 314 adjusts the size of the subject in the composite image data 331 so that the size of the reference area coincides with the reference size received by the reference receiving part 313. Concretely, the reference size and the size of the reference area are compared with each other, and a scaling factor for enlargement or reduction for making the size of the reference area coincide with the reference size is derived. As the size of the reference area, the number of pixels of one side of the reference area is used. On the basis of the derived scaling factor for enlargement or reduction, the composite image data 331 is enlarged or reduced. In such a manner, the size of the whole subject in the composite image data 331 is adjusted. The size of the reference area in the adjusted composite image data 331 coincides with the reference size (step ST19).

After the brightness and the size of the subject are adjusted, by means of the display data generating part 316, the composite spectral distribution I(λ) of each pixel in the composite image data 331 is converted to XYZ values by the computation of Equation 4 and is further converted to the RGB values. The adjusted composite image data 331 is displayed on the display 305. The user can therefore view the generated composite image data 331. For the conversion from the XYZ values to the RGB values, an ICC profile indicative of characteristics peculiar to the display 305 may be used. By using the ICC profile for conversion, the characteristics peculiar to the display 305 can be eliminated from an image displayed on the display 305 (step ST20).

After the composite image data 331 generated from one target object-color component data is displayed in such a manner, the next target object-color component data is determined (steps ST21 and ST15). The same processes (step S16 to ST20) are performed on the target object-color component data. By repeating such processes, the composite image data 331 is generated from each of all of the object-color component data 233 to be compared. Each of the plurality of pieces of composite image data 331 generated is displayed on the display 305.

In the processes, the same illuminant component data (i.e., the illuminant component data 232) is used for generating the plurality of pieces of composite image data 331 using the plurality of pieces of object-color component data 233 to be compared. Therefore, also in the case where spectral distributions of illumination light when the plurality of pieces of object-color component data 233 are obtained are different from each other, the plurality of pieces of generated composite image data 331 form images of the subject illuminated with the illumination light of the same spectral distribution. That is, the images of the subject illuminated with illumination light of the same spectral distribution can be reproduced and the same subject is reproduced in the same color. Thus, the user can compare the images of the subject illuminated with the illumination light of the same spectral distribution, and the comparison is accurately made. Since the instruction of selecting one piece of the illuminant component data 232 used for generating the composite image data 331 is received from the user, an image of the subject illuminated with illumination light of a spectral distribution desired by the user can be reproduced.

Since the object-color component data 233 indicates a relative spectral reflectance, in the case of simply combining the illuminant component data 232 into the object-color component data 233, the brightness of the composite image data 331 to be generated is influenced by the intensity of illumination light at the time of obtaining the object-color component data 233. In this case, therefore, there is the possibility that the same subject is not reproduced with the same brightness at the time of reproduction of the plurality of pieces of composite image data 331. In the preferred embodiment, therefore, the brightness of the composite image data 331 is adjusted so that the brightness of the reference area coincides with the reference value, and the same brightness of the reference area is achieved among the plurality of pieces of the composite image data 331. Therefore, the plurality of pieces of composite image data 331 form images of the subject illuminated with the illumination light of the same intensity. That is, the images of the subject illuminated with illumination light of the same intensity can be reproduced, and images of the same subject are reproduced with the same brightness. The user can consequently compare the images of the subject with illumination light of the same intensity with each other, and the comparison of images of the subject can be performed more accurately. Since designation of the reference value as a reference for making brightness of the reference areas match each other is received from the user, an image of the subject illuminated with illumination light of an intensity desired by the user can be reproduced.

In the case of simply combining the illuminant component data 232 into the object-color component data 233, the size of the subject in the composite image data 331 to be generated is influenced by a photographing distance at the time of capturing the object-color component data 233. In this case, therefore, there is the possibility in that the same subject is not reproduced with the same size at the time of reproduction of the plurality of pieces of composite image data 331. In the preferred embodiment, the size of the subject in the composite image data 331 is adjusted (enlarged or reduced) so that the size of the reference area coincides with the reference size, and the same size of the reference area is achieved among the plurality of pieces of the composite image data 331. Therefore, the plurality of pieces of composite image data 331 form images of the actual subject at the same scale. That is, images of the subject can be reproduced at the same scale, and images of the same subject are reproduced in the same size. The user can consequently compare the images of the subject at the same scale with each other, and the comparison of images of the subject can be performed more accurately. Since designation of the reference size as a reference for making the size of the reference areas match each other is received from the user, an image of the subject can be reproduced at a scale desired by the user.

The plurality of pieces of composite image data 331, which have been generated, are recorded on the hard disk 304 by the composite image recording part 315 and stored as a composite image database 353 (step ST22). By storing the plurality of pieces of composite image data 331 generated in such a manner as a database, it becomes unnecessary to generate the composite image data 331 at the time of reproducing an image of the subject again by the object-color component data 233, and the user can view an image of the subject as a target in short time. Whether a plurality of pieces of composite image data 331, which have been generated, are recorded or not can be designated by the user.

As described above, in the preferred embodiment, the plurality of pieces of composite image data 331 are generated from the plurality of object-color component data 237, the brightness and the size of the subject are adjusted and, after that, the resultant is displayed so that the user can view it. In such a manner, images of the subject at the same scale illuminated with illumination light of the same spectral distribution and the same intensity can be reproduced in the plurality of pieces of composite image data 331. Thus, images of the subject formed by the plurality of pieces of composite image data 331 can be accurately compared with each other.

The plurality of pieces of composite image data 331 to be generated can be used, for example, as images for observing progress of treatment on an affected area of a patient in a medical practice. Specifically, the object-color component data 233 of an affected area of a patient as a subject is captured at different times. The user as a doctor views a plurality of pieces of composite image data 331 generated from the plurality of pieces of object-color component data 233 and can accurately observe progress of treatment on the affected area. Since the illuminant component data 232 used for generating the composite image data 331 can be selected, by selecting data adapted to illumination light which is used usually, the user as a doctor can view the subject (such as an affected area of a patient) under familiar illumination light conditions. Thus, precision in consultation and diagnosis can be improved.

The plurality of pieces of composite image data 331 to be generated can be also suitably used as an image used for printing of a catalog including pictures of a plurality of commodities. In the case of using the plurality of pieces of composite image data 331 for printing, a printing part such as a printer serves as an output part for outputting the plurality of pieces of composite image data 331 so as to be viewed. According to the method of the preferred embodiment, images of the subjects (commodities) are reproduced under the same conditions even in a plurality of images obtained at different occasions, so that commodities in the catalog can be compared with each other accurately. By selecting data adapted to standard light such as D65 in the CIE standard or D50 in the CIE standard as the illuminant component data 232, colors of the subjects (commodities) in an image can be reproduced accurately, so that the color difference between an actual commodity and a commodity in an image can be solved. Similarly, a plurality of pieces of composite image data 331 to be generated can be used suitably as images for Internet shopping or the like.

2. Second Preferred Embodiment

A second preferred embodiment of the present invention will now be described. In the first preferred embodiment, since the object-color component data 233 indicates the relative spectral reflectance, the brightness is adjusted at the time of reproducing the composite image data 331. In the second preferred embodiment, the digital camera 1 obtains the object-color component data indicative of absolute spectral reflectance, thereby making adjustment of brightness at the time of reproduction unnecessary.

An image processing system applied to the second preferred embodiment is similar to that of FIG. 1 and the configurations of the computer 3 and digital camera 1 are similar to those shown in FIGS. 2 and 3. Consequently, points different from the first preferred embodiment will be mainly described below.

2-1. Acquisition of Object-Color Component Data

First, a process of obtaining object-color component data indicative of absolute spectral reflectance by the digital camera 1 of the second preferred embodiment will be described.

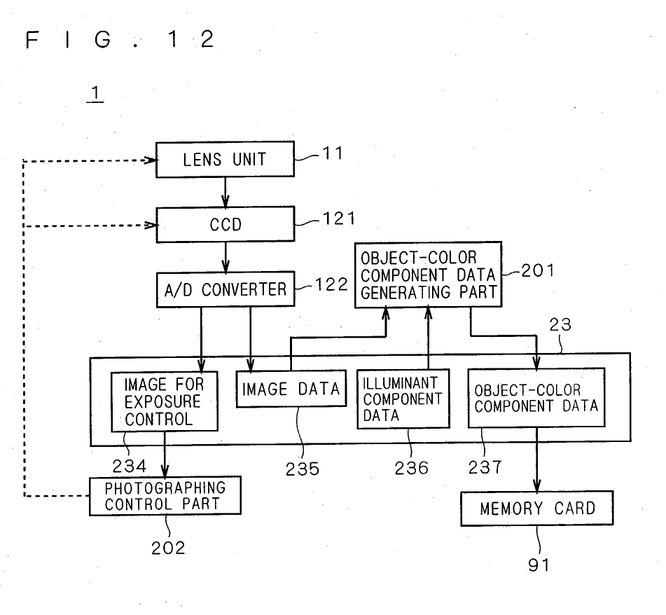

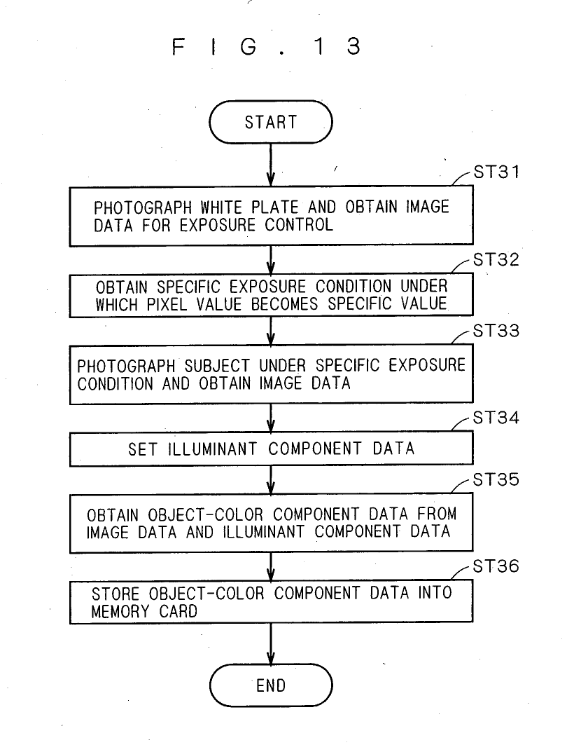

FIG. 12 is a block diagram showing functions realized by the CPU 21, ROM 22 and RAM 23 of the digital camera 1 according to the second preferred embodiment together with the other configuration. In the configuration shown in FIG. 12, the object-color component data generating part 201 and a photographing control part 202 are realized by the CPU 21, ROM 22, RAM 23 and the like. FIG. 13 is a flowchart showing the flow of photographing and imaging processes of the digital camera 1. An operation of obtaining object-color component data of the digital camera 1 will be described below with reference to FIGS. 12 and 13.

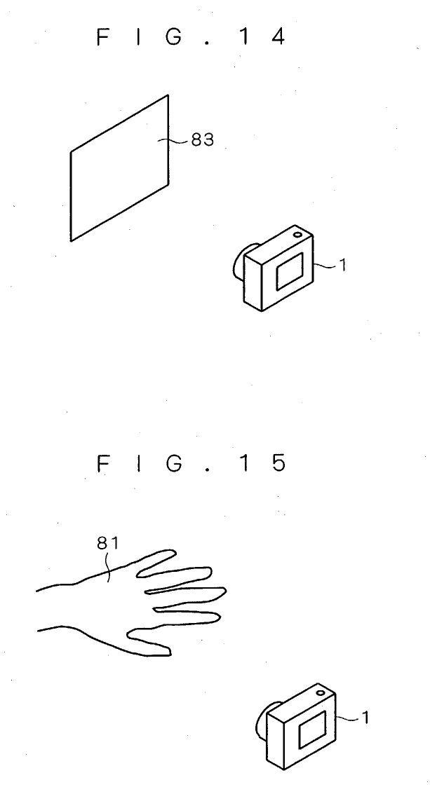

First, prior to acquisition of image data for obtaining the object-color component data, the calibration plate 83 as a reference subject is photographed as shown in FIG. 14, and an image 234 for determining exposure conditions (hereinafter, referred to as “image for exposure control”) is acquired. In the preferred embodiment, a white plate having a rectangular shape and whose whole surface is white is used as the calibration plate 83. The spectral reflectance of the calibration plate 83 is preliminarily measured and known. At the time of photographing, the digital camera 1 and the calibration plate 83 are disposed so that the image capturing face of the digital camera 1 and the calibration plate 83 become parallel to each other and an image through the viewfinder of the digital camera 1 is occupied only by the calibration plate 83 (step ST31). It is sufficient for the calibration plate 83 to have an achromatic color. The calibration plate 83 of gray or the like may be also used.

A predetermined program chart is referred to on the basis of the obtained image 234 for exposure control, and an exposure condition at the time of photographing a subject is obtained by the photographing control part 202. The exposure condition to be obtained is such that when the calibration plate 83 is photographed under the exposure condition, a pixel value in an area indicative of the calibration plate 83 in image data obtained becomes a specified value (hereinafter, referred to as “specified exposure condition”). Since the calibration plate 83 has an achromatic color, the pixel value referred to when the specified exposure condition is obtained may be any of R, G and B. For example, a pixel value of G is referred to. When the pixel value is expressed in, for example, eight bits (in this case, “255” is the maximum value), the specified value is set to “245”.

The digital camera 1 according to the preferred embodiment performs an exposure control by adjusting the aperture diameter of the aperture 112 in the lens unit 11 and exposure time of the CCD 121. From the image capturing control part 202, signals are transmitted to the lens unit 11 and the CCD 121 and a control is performed so that photographing after that is performed under the specified exposure condition (step ST32).

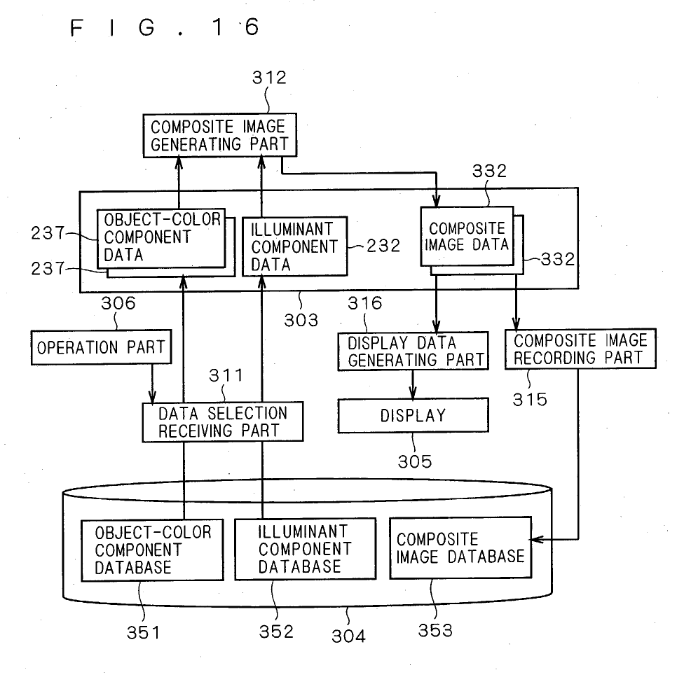

After that, the subject of which object-color component data is to be obtained is photographed under the specified exposure condition and image data 235 is stored into the RAM 23 (step ST33). It is unnecessary to photograph the patch 82 at the same time of the photographing. As shown in FIG. 15, only the main subject 81 is photographed.

Subsequently, illuminant component data 236 used for obtaining the object-color component data is set. In the ROM 23 of the digital camera 1, a plurality of pieces of illuminant component data 236 for various illumination light (light sources) are prestored. According to a light source used at the time of photographing, the user selects one of the plurality of pieces of illuminant component data 236 by the operation button 126 (step ST34).

The illuminant component data 236 according to the preferred embodiment has a relative spectral distribution of illumination light like the illuminant component data 232 according to the first preferred embodiment. However, the intensity of the spectral distribution of the illuminant component data 236 is preliminarily adjusted on the basis of a specific value. Concretely, when the spectral distribution of illumination light which is normalized by using the maximum spectral intensity as 1 is set as Eₒ(λ) and a spectral distribution indicated by the illuminant component data 236 used in the second preferred embodiment is set as Eₐ(λ), as shown by Equation 5, the intensity of the spectral distribution Eₐ(λ) is adjusted by a coefficient k.

Eₐ(λ)=k·Eₐ(λ) Equation 5

The coefficient k is determined so that a pixel value (regarding, for example, G) theoretically derived from the spectral distribution Eₐ and the spectral reflectance of the calibration plate 83 coincides with a specific value. When a theoretical value of the pixel value is ρ_{g}, the theoretical value ρ_{g} is given as follows.

$$\begin{matrix}{ρ}_{g} = \int {R}_{R} ( λ ) \cdot {E}_{a} ( λ ) \cdot {S}_{w} ( λ ) ⅆ λ \\ = \int {R}_{g} ( λ ) \cdot k \cdot {E}_{a} ( λ ) \cdot {S}_{w} ( λ ) ⅆ λ\end{matrix} \qquad Equation 6$$

In Equation 6, R_{g}(λ) denotes total spectral sensitivity (regarding, for example, G) of the digital camera 1 and S_{w}(λ) denotes absolute spectral reflectance of the calibration plate 83 and both of the values are known. The coefficient k is determined by substituting the specific value for ρ_{g} in Equation 6. That is, the intensity of the spectral distribution Eₐ is preliminarily adjusted so that the theoretical value ρ_{g} of the pixel value derived on the basis of the spectral distribution Eₐ and the spectral reflectance S_{w}(λ) coincides with the specific value. In the ROM 23 of the digital camera 1, the illuminant component data 236 indicative of the spectral distribution of which intensity is adjusted on the basis of the specific value is prestored.

After the illuminant component data 236 is set, object-color component data 237 is obtained as a component obtained by eliminating the influence of an illumination environment from the image data 235 by using the image data 235 and the illuminant component data 236 by the object-color component data generating part 201. As a method of obtaining the object-color component data 237, the same method as that of the first preferred embodiment is employed (step ST35). The obtained object-color component data 237 is transferred to the memory card 91 and stored (step ST36).

It is now assumed that the object-color component data 237 is obtained on the basis of image data acquired by photographing the calibration plate 83 by the method of the preferred embodiment. Since the calibration plate 83 is photographed under the specific exposure condition, irrespective of the intensity of actual illumination light, pixel values of all of R, G and B in the obtained image data are specific values. By using the pixel values (that is, the specific values) and the illuminant component data 236 indicative of the spectral distribution Eₐ adjusted on the basis of the specific values, the object-color component data 237 is obtained. Therefore, the object-color component data 237 obtained indicates the absolute spectral reflectance S_{w}(λ) of the calibration plate 83.

A case of obtaining the object-color component data 237 on the basis of image data captured by photographing a general subject other than the calibration plate 83 will now be assumed. In this case as well, the subject is photographed under the specific exposure condition, so that irrespective of the intensity of actual illumination light, the pixel values of all of R, G and B in the obtained image data become values relative to the specific value. By using the pixel value (relative value to the specific value) and the illuminant component data 236 indicative of the spectral distribution Eₐ adjusted on the basis of the specific value, the object-color component data 237 is obtained. The object-color component data 237 to be obtained consequently indicates a relative value to the spectral reflectance obtained from the specific value. The spectral reflectance obtained from the specific value denotes the absolute spectral reflectance S_{w}(λ) of the calibration plate 83. Consequently, the object-color component data 237 indicates absolute spectral reflectance of the subject. Therefore, by employing the method of the preferred embodiment, irrespective of the intensity of the actual illumination light, the object-color component data 237 indicative of the absolute spectral reflectance of the subject can be derived.

2-2. Reproduction of Object-Color Component Data

A process of reproducing image data by using the object-color component data 237 obtained as described above by the computer 3 according to the preferred embodiment will now be described.

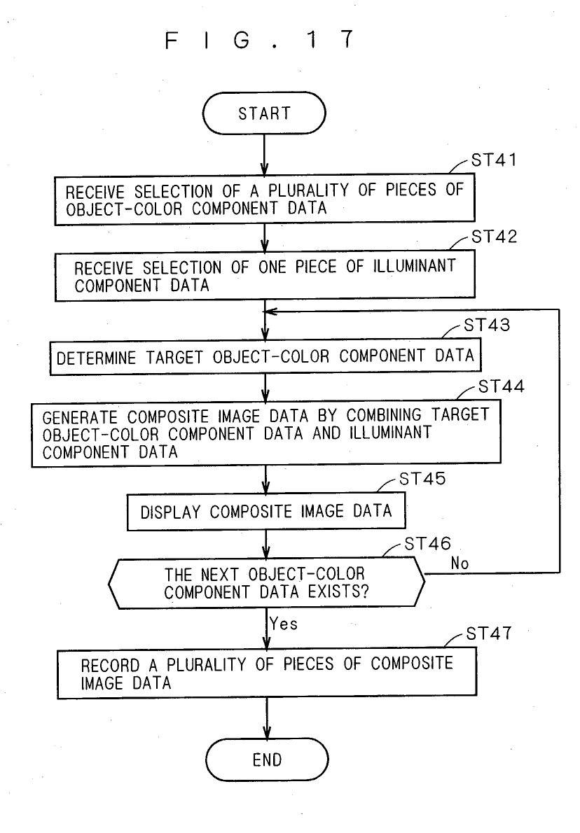

FIG. 16 is a block diagram showing functions realized when the CPU 301 of the computer 3 according to the preferred embodiment operates according to the program 341 together with the other configuration. As understood from comparison between FIGS. 16 and 7, the computer 3 of the preferred embodiment has the configuration obtained by eliminating the reference receiving part 313 and the image adjusting part 314 from the configuration shown in FIG. 7.

The object-color component database 351 constructed in the hard disk 304 is constructed by a plurality of pieces of object-color component data 237 indicative of the absolute spectral reflectance of the subject. On the other hand, the illuminant component database 352 is constructed by a plurality of pieces of illuminant component data 232 indicative of a spectral distribution of illumination light normalized by using the maximum spectral intensity as 1.

FIG. 17 is a flowchart of a process realized by the CPU 301 in accordance with the program 341. Concretely, FIG. 17 shows the flow of a process of reproducing composite image data by using the object-color component data 237. The process of the preferred embodiment is different from the process of FIG. 8 and does not include the adjustment of brightness and the adjustment of the size of the subject on the composite image data. With reference to FIGS. 16 and 17, the process of the computer 3 of the preferred embodiment will be described below.

First, a plurality of object-color component data 237 are selected from the object-color component database 351 by the instruction of the user via the operation part 306. The selected plurality of pieces of object-color component data 237 are read to the RAM 303. In such a manner, the plurality of pieces of object-color component data 237 desired by the user to be compared are determined (step ST41).

After that, according to an instruction of the user via the operation part 306, one of the plurality of pieces of illuminant component data 232 used for generating composite image data is selected from the illuminant component database 352. The selected illuminant component data 232 is read to the RAM 303 (step ST42).

One of the plurality of pieces of object-color component data 237 read to the RAM 303 is determined as target object-color component data (step ST43).

Subsequently, the target object-color component data and the illuminant component data 232 are inputted to the composite image generating part 312. The composite image generating part 312 obtains the spectral reflectance S(λ) in a position on the subject by using data corresponding to each pixel of the target object-color component data as the weighted coefficient σⱼ of Equation 1. The spectral reflectance S(λ) is absolute spectral reflectance. The obtained spectral reflectance S(λ) and the spectral distribution E(λ) of illumination light indicated by the illuminant component data 232 are used for Equation 2, thereby obtaining the composite spectral distribution I(λ). By the computation, composite image data 332 whose each pixel is expressed by the composite spectral distribution I(λ) is generated (step ST44). The composite spectral distribution I(λ) of each pixel in the composite image data 332 is converted into XYZ values by computation of Equation 4 by the display data generating part 316 and the XYZ values are further converted into RGB values. Consequently, the adjusted composite image data 332 is displayed on the display 305 and an image of the subject formed by the target object-color component data is reproduced (step ST45).

After the composite image data 332 generated from one of the target object-color component data is displayed, the next target object-color component data is determined (steps ST46 and ST43). The same process is performed on the target object-color component data. By repeating the process, the composite image data 332 is generated from each of all of the object-color component data 237 to be compared. Each of the plurality of pieces of composite image data 332, which has been generated, is displayed on the display 305. Further, the plurality of pieces of composite image data 332 are recorded into the hard disk 304 and stored as the composite image database 353 (step ST47).

In the second preferred embodiment as well, the illuminant component data 232 used for generating the composite image data 332 is the same among the plurality of pieces of object-color component data 237 to be compared, so that images of a subject under the illumination light condition of the same spectral distribution can be reproduced. Each of the plurality of pieces of object-color component data 237 indicates an absolute spectral reflectance, so that the plurality of pieces of composite image data 332 form images of the subject illuminated with illumination light of substantially the same intensity. That is, without adjusting the brightness of the composite image data 332, images of the same subject are reproduced with the same brightness. Therefore, in the preferred embodiment, images of the subject under the illumination light conditions of the same spectral distribution and the same intensity can be reproduced among the plurality of pieces of composite image data 332. Consequently, in a manner similar to the first preferred embodiment, images of the subject formed by the plurality of pieces of composite image data 331 can be compared with each other accurately.

3. Modifications

In the foregoing preferred embodiments, the process of obtaining the object-color component data from the image data is performed by the digital camera 1. A part of the process may be performed by the computer 3. In this case, the process can be arbitrarily shared between the digital camera 1 and the computer 3.

Although it has been described in the foregoing preferred embodiments that the weighted coefficients σ₁, σ₂ and σ₃ corresponding to pixels are stored as the object-color component data, the data may be stored together with the basis functions S₁(λ), S₂(λ) and S₃(λ) of the spectral reflectance of the subject. Alternatively, it is also possible to express the spectral reflectance by a weighted sum of n (n>3) basis functions and n weighted coefficients and use the n weighted coefficients as object-color component data. Further, the characteristic curve itself of the spectral reflectance may be used as the object-color component data.

The spectral distribution E(λ) may be expressed as a weighted sum of the three basis functions E₁(λ), E₂(λ) and E₃(λ) and weighted coefficients ε₁, ε₂ and ε₃ like the spectral reflectance of the subject, and the weighted coefficients ε₁, ε₂ and ε₃ may be used as illuminant component data.

Although it has been described in the first preferred embodiment that at the time of adjusting brightness and the size of a subject, each of pixels of the composite image data 331 is expressed by the composite spectral distribution I(λ), the pixel may be expressed by the XYZ values or RGB values. In the case where the pixel value is expressed by the XYZ values, the Y value may be used as brightness of the reference area. In the case where the pixel value is expressed by the RGB values, the G value may be used.

Although it has been described in the first preferred embodiment that the reference value of brightness and the reference size are designated by the user, brightness and size of a reference area in one of the plurality of pieces of composite image data 331, which has been generated, may be used as a reference value of brightness and a reference size, respectively. Further, the reference value of brightness and the reference size may be predetermined values. In this manner, even when a process of generating the composite image data 331 is performed in a plurality of steps, the reference value of brightness and the reference size become always constant. Therefore, in the case of viewing the composite image data 331 stored as the composite image database 353, when a plurality of pieces of composite image data 331 generated by processes different from each other are to be viewed, images of the subject under the same conditions can be compared with each other.

Relatively small thumbnail images may be preliminarily generated from object-color component data included in the object-color component database 351 and one of the plurality of pieces of illuminant component data and a list of thumbnail images may be displayed at the time of selecting the object-color component data. Although the object-color component data itself cannot be provided for display, by displaying such a thumbnail image, selection of the object-color component data is facilitated.

In the foregoing preferred embodiment, it has been described that the object-color component database 351 and the illuminant component database 352 are constructed in the computer 3, the databases may be constructed in an external server device or the like. In this case, the computer 3 obtains the object-color component data and illuminant component data necessary from the server device via the network or the like.

Although it has been described in the foregoing preferred embodiments that various functions are realized when the CPU performs a computing process in accordance with a program, all or a part of the functions may be realized by a dedicated electrical circuit. Particularly, by constructing a part in which computation is repeated by a logic circuit, high-speed computation is realized.

While the invention has been shown and described in detail, the foregoing description is in all aspects illustrative and not restrictive. It is therefore understood that numerous modifications and variations can be devised without departing from the scope of the invention.

What is claimed is:

1. An image processing apparatus comprising:
an image generating part for generating a plurality of pieces of composite image data by combining the same illuminant component data indicative of a spectral distribution of illumination light into each of a plurality of pieces of object-color component data corresponding to image data from which an influence of illumination light to a subject is eliminated; and
an output part for outputting said plurality of pieces of composite image data, which have been generated, so as to be viewed.

2. The image processing apparatus according to claim 1, wherein
each of said plurality of pieces of composite image data includes a reference area obtained by photographing a reference subject of an achromatic color, and
said image processing apparatus further comprises:
an image adjusting part for adjusting brightness of each of said plurality of pieces of composite image data so that said reference areas in said plurality of pieces of composite image data have the same brightness.

3. The image processing apparatus according to claim 1, wherein
each of said plurality of pieces of composite image data includes a reference area obtained by photographing a reference subject of a predetermined size, and
said image processing apparatus further comprises:
an image adjusting part for adjusting a size of the subject in each of said plurality of pieces of composite image data so that said reference areas of said plurality of pieces of composite image data have the same size.

4. The image processing apparatus according to claim 1, further comprising:
a selection receiving part for receiving selection of one of a plurality of candidates of illuminant component data, which is used to generate said composite image data.

5. The image processing apparatus according to claim 2, further comprising:
a reference receiving part for receiving designation of a reference value as a reference for making said reference areas have the same brightness.

6. The image processing apparatus according to claim 3, further comprising:
a reference receiving part for receiving designation of a reference size as a reference for making said reference areas have the same size.

7. The image processing apparatus according to claim 1, further comprising:
an image recording part for recording said plurality of pieces of composite image data which have been generated.

8. An image processing apparatus comprising:
an image generating part for generating a plurality of pieces of composite image data by combining the same illuminant component data indicative of a spectral distribution of illumination light into each of a plurality of pieces of object-color component data corresponding to image data from which an influence of illumination light to a subject is eliminated; and
an image recording part for recording said plurality of pieces of composite image data, which have been generated, to construct a database.

9. An image processing method comprising the steps of:
generating a plurality of pieces of composite image data by combining the same illuminant component data indicative of a spectral distribution of illumination light into each of a plurality of pieces of object-color component data corresponding to image data from which an influence of illumination light to a subject is eliminated; and
outputting said plurality of pieces of composite image data, which have been generated, so as to be viewed.

10. The image processing method according to claim 9, wherein
each of said plurality of pieces of composite image data includes a reference area obtained by photographing a reference subject of an achromatic color, and
said image processing method further comprises the step of:
adjusting brightness of each of said plurality of pieces of composite image data so that said reference areas of said plurality of pieces of composite image data have the same brightness.

11. The image processing method according to claim 9, wherein
each of said plurality of pieces of composite image data includes a reference area obtained by photographing a reference subject of a predetermined size, and
said image processing method further comprises the step of:
adjusting a size of the subject in each of said plurality of pieces of composite image data so that said reference areas of said plurality of pieces of composite image data have the same size.

12. The image processing method according to claim 9, further comprising the step of:
receiving selection of one of a plurality of candidates of illuminant component data, which is used to generate said composite image data.

13. The image processing method according to claim 10, further comprising the step of:
receiving designation of a reference value as a reference for making said reference areas have the same brightness.

14. The image processing method according to claim 11, further comprising the step of:
receiving designation of a reference size as a reference for making said reference areas have the same size.

15. The image processing method according to claim 9, further comprising the step of:
recording said plurality of pieces of composite image data which have been generated.

16. An image processing method comprising the steps of:
generating a plurality of pieces of composite image data by combining the same illuminant component data indicative of a spectral distribution of illumination light into each of a plurality of pieces of object-color component data corresponding to image data from which an influence of illumination light to a subject is eliminated; and
recording said plurality of pieces of composite image data which have been generated, to construct a database.

17. A program product having a program for allowing a computer to execute an imaging process, said program allowing said computer to execute the steps of:
generating a plurality of pieces of composite image data by combining the same illuminant component data indicative of a spectral distribution of illumination light into each of a plurality of pieces of object-color component data corresponding to image data from which an influence of illumination light to a subject is eliminated; and
outputting said plurality of pieces of composite image data, which have been generated, so as to be viewed.

18. The program product according to claim 17, wherein
each of said plurality of pieces of composite image data includes a reference area obtained by photographing a reference subject of an achromatic color, and
said program allows said computer to further execute the step of:
adjusting brightness of each of said plurality of pieces composite image data so that said reference areas in said plurality of pieces of composite image data have the same brightness.

19. The program product according to claim 17, wherein
each of said plurality of pieces of composite image data includes a reference area obtained by photographing a reference subject of a predetermined size, and
said program allows said computer to further execute the step of:
adjusting a size of the subject in said plurality of pieces of composite image data so that said reference areas in said plurality of pieces of composite image data have the same size.

20. The program product according to claim 17, wherein
said program allows said computer to further execute the step of:
receiving selection of one of a plurality of candidates of illuminant component data, which is used to generate said composite image data.

21. The program product according to claim 18, wherein
said program allows said computer to further execute the step of:
receiving designation of a reference value as a reference for making said reference areas have the same brightness.

22. The program product according to claim 19, wherein
said program allows said computer to further execute the step of:
receiving designation of a reference size as a reference for making said reference areas have the same size.

23. The program product according to claim 18, wherein
said program allows said computer to further execute the step of:
recording said plurality of pieces of composite image data which have been generated.

24. A program product having a program for allowing a computer to execute an imaging process, said program allowing said computer to execute the steps of:
generating a plurality of pieces of composite image data by combining the same illuminant component data indicative of a spectral distribution of illumination light into each of a plurality of pieces of object-color component data corresponding to image data from which an influence of illumination light to a subject is eliminated; and
recording said plurality of pieces of composite image data which have been generated, to construct a database.

25. An image processing method comprising the steps of:
(a) obtaining a specific exposure condition under which a pixel value in an area indicative of a reference subject of an achromatic color in image data obtained by photographing said reference subject becomes a specific value;
(b) photographing a subject under said specific exposure condition to obtain image data; and
(c) obtaining object-color component data corresponding to image data from which an influence of illumination light to said subject is eliminated on the basis of the image data obtained in step (b) and a spectral distribution of the illumination light to said subject, wherein
intensity of the spectral distribution of said illumination light is adjusted so that a theoretical value of said pixel value derived on the basis of the spectral distribution of the illumination light and spectral reflectance of said reference subject coincides with said specific value.

26. The image processing method according to claim 25, further comprising steps of:
generating a plurality of pieces of composite image data by combining the same illuminant component data indicative of a spectral distribution of illumination light into each of a plurality of pieces of object-color component data obtained in step (c); and
outputting said plurality of pieces of composite image data, which have been generated, so as to be viewed.
